(19) United States
(12) Patent Application Publication
(10) Pub. No.: US 2025/0083163 A1
(43) Pub. Date: Mar. 13, 2025

(54) Triple shot spray attachment

(71) Applicant: Danny Breeden, Midwest City, OK (US)

(72) Inventor: Danny Breeden, Midwest City, OK (US)

(21) Appl. No.: 18/445,511

(22) Filed: Sep. 13, 2023

(51) Int. Cl. B05B 7/24; B05B 12/32; B05B 15/40

(52) U.S. Cl. CPC B05B 7/2486; B05B 12/32; B05B 15/40

(57) ABSTRACT

A triple shot spray attachment for a pressurize spray provides three independently adjustable spray nozzles for application of paint, coatings or fluids to both flat and contoured surfaces and shaped objects, and is fully disassembled after use for cleaning

### CROSS REFERENCE TO RELATED APPLICATIONS

None.

### I. BACKGROUND OF THE INVENTION

### 1. Field of Invention

An airless sprayer attachment to apply a liquid material to surfaces provides three spray heads, including a central fixed position spray head and two outer multiple position spray head extending from a common spray manifold to increase the spray coverage width and spray contour of the liquid materials being applied with the airless sprayer and this attachment, adjusted to suit the surface and contour of a target being sprayed.

### 2. Description of Prior Art

A preliminary review of prior art patents was conducted by the applicant which reveal prior art patents in a similar field or having similar use. However, the prior art inventions do not disclose the same or similar elements as the present spray attachment, nor do they present the material components in a manner contemplated or anticipated in the prior art.

A multi-path spray gun is disclosed in U.S. Pat. No. 5,957,386 to Bialke which disperses atomized fluids to a surface. It spray nozzles are in a fixed position and provide intersecting coverages and uses pressurized air to conduct its application. In U.S, Patent Publication 2002/0096579 to Sinders, an airless spray nozzle provides for variable angular application of its liquids to a surface between 0 and 60 degrees and adjusts the width of the spray.

As a matter of disclosure only, three Chinese patents are referenced to indicate triple output spray nozzles which are attached to a unitized dispersion appliance in Chinese Patents No. CN 213727266 and CN 206951457, while Chines Patent No. CN 115569752 provides a common spray attachment with a central spray nozzle and multiple peripheral spray nozzles in a common spray nozzle.

None of the discovered prior art discloses the central fixed position spray extension with two adjacent adjustable spray wands, multiple adjustable spray heads or independently adjustable triple or more spray heads.

### II. SUMMARY OF THE INVENTION

The application of coatings or forced pressure spraying is used in painting, washing, application of coal tar epoxies and other special coatings, most often by professionals. They use air application devices, where pressurized air is used to atomize and project these coatings and also airless devices which apply coatings directly from a production source, including cans, tubs, and other containers. These spray devices use application tips that spread the atomized and create aerosols which distribute the paint in selected patterns and in selected quantities.

The present triple shot spray adapter applies the coatings in greater quantities and with greater efficiencies than single spray heads or other multiple head sprayers, by placing three application heads in a three dimensional array which is multiply adjusted for targets that are flat or not flat surfaces, including rounded surfaces shaped surfaces, multiple shaped surfaces, ples and corners. This three dimensional spray capacity is provided by three independently adjustable spray nozzles on three independent spray arms, each spray arm and nozzle fully adjustable from 1 to 360 degrees. The three spray arms are provided in several selected lengths to increase the spread of the aerosol coating, adjust the spray pattern for non-flat surfaces or reduce the spray pattern for tighter or more concentrated spray treatments, as subjectively desired by the user. The arms may be directed parallel or in different directions to effect the contours of the target object being treated or coated, as indicated in the drawing figures.

The triple shot spray adapter is able to be fully disassembled for cleaning after use with common tools already used in the spray coating industry. It is also supplied with metric and American standard dimensions. It may be used with a single gun, extension pole or multiple guns from a common source. It may also be connected to industrial power washers. Prior art devices do not present any sprayer with the same elements and combinations as the triple shot spray adapter, nor do they combine to anticipate the assembled components in the same manner as the present triple shot spray adapter.

### III. DESCRIPTION OF THE DRAWINGS

The following drawings are submitted with this utility patent application.

FIG. 1 is a perspective view of the triple shot spray attachment connecting to the nozzle of a pressurized spray device.

FIG. 2 is a top view of the triple shot spray apparatus indicating movement of the adjustable swivel elbows.

FIG. 3 is a perspective view of the triple shot spray attachment.

FIG. 4 is an exploded view of the triple shot spray attachment.

FIG. 5 is an exploded view of a left swivel elbow.

FIG. 6 is an exploded view of a right swivel elbow.

FIG. 7 is a sectional view of the left swivel elbow along section lines 7/7 of FIG. 5.

FIG. 8 is a sectional view of the right swivel elbow along section lines 8/8 of FIG. 6.

FIG. 9A is a view of the triple shot being used to spray a liquid on a round post.

FIG. 9B is a view of the triple shot being used to spray a liquid on a square object.

FIG. 9C is the triple shot being used to spray a liquid on a rounded surface.

### IV. DESCRIPTION OF THE PREFERRED EMBODIMENT

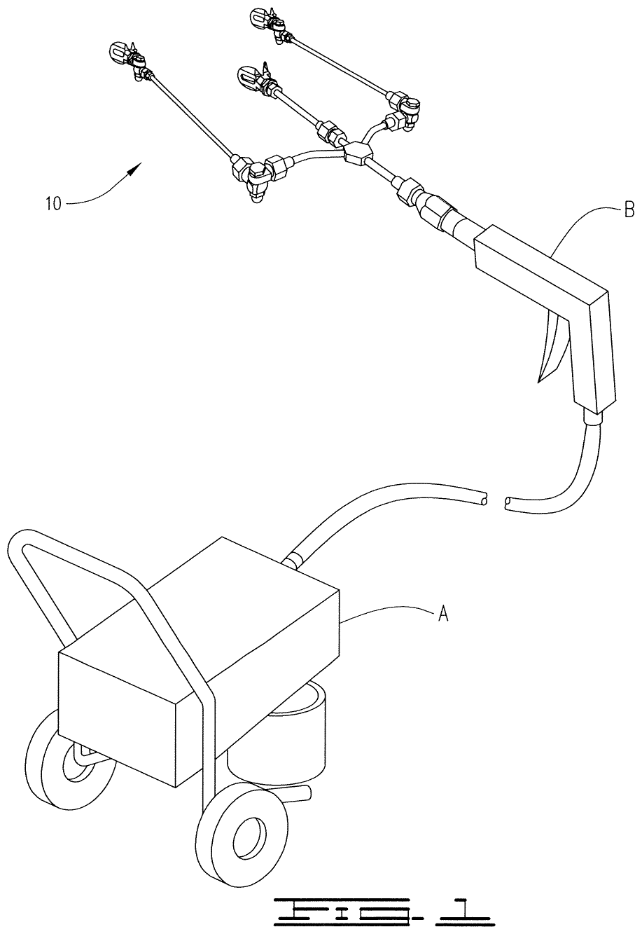

A triple shot spray attachment 10 for a pressurized spray device A provides an expanded spray pattern for increased application and also for a contoured spray target. The triple shot spray attachment has a filter body 15 that attaches to the spray gun B of the pressurized spray device A, FIG. 1. The filter body 15 has multiple adapters 12 which provide for universal attachment to the spray gun B, both metric and American standard, with multiple thread offerings. The filter body 15 has an internal passage 16 which provides for the insertion of a disposable internal filter 17, FIG. 4.

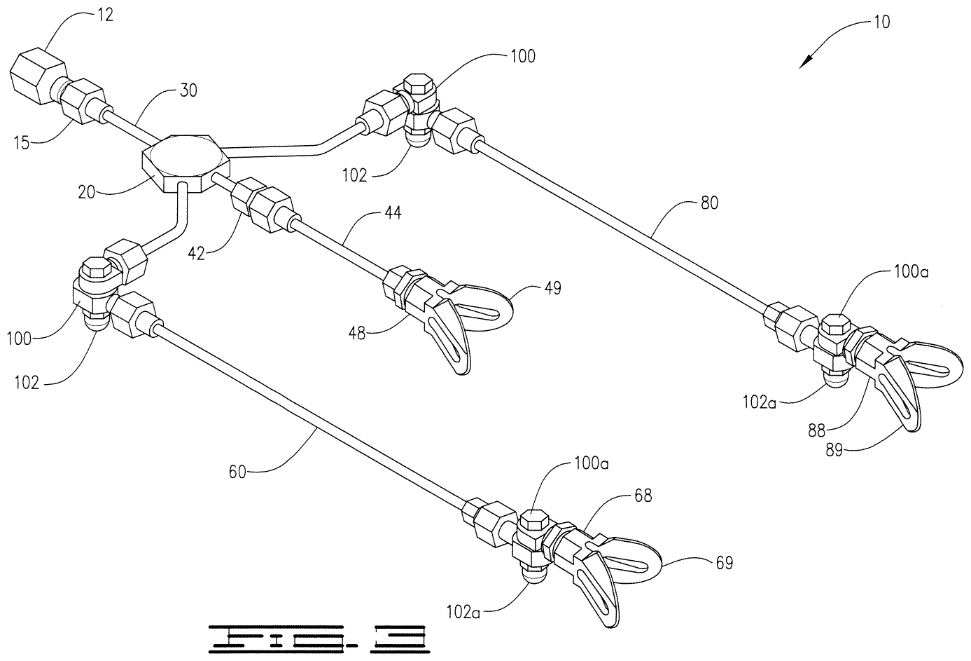

A triple shot separator manifold 20, FIGS. 1-4 and 9A-9C, has a lower extension 34 fitting to the filter body 15 and inserting into a lower end 32 of a separator body 22 by a straight lower hollow tube 30. The triple shot separator manifold 20 evenly distributes fluid flow through the separator manifold 20 to an upper port 40, a right side port 50 and a left side port 70. Each port defines a respective port fitting 42, 52, 72. The upper port is attached to a tubular extension 44 which provides for attachment to a first nozzle fitting 45 using a filter boss 46 and a flat tip spray nozzle 48. Optionally, the first nozzle fitting 45 may be attached directly to the upper port fitting 42 using the filter boss 46 and flat spray tip nozzle 48, not shown. Each left and right side ports 50, 70 are attached to shaped tubing 54, 74, each respective tubing defining a respective right and left terminal port fitting 56, 76.

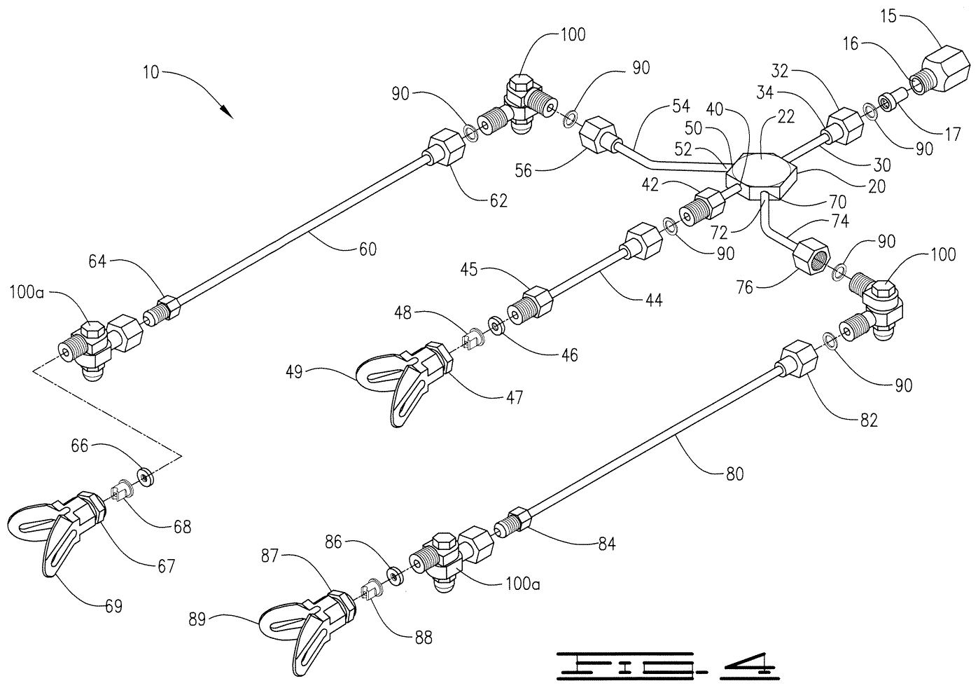

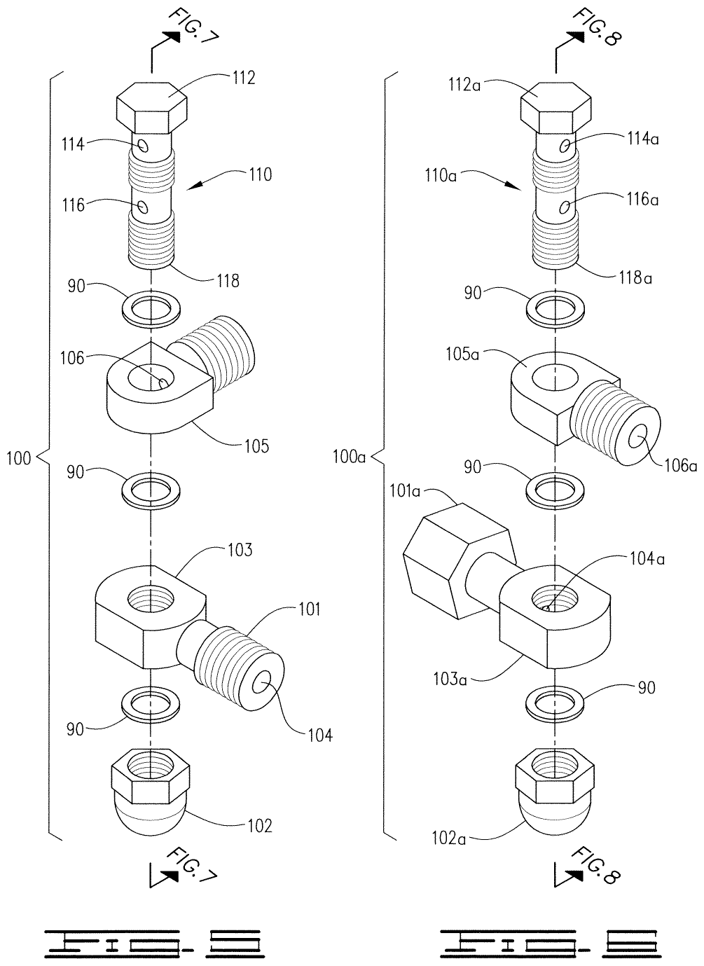

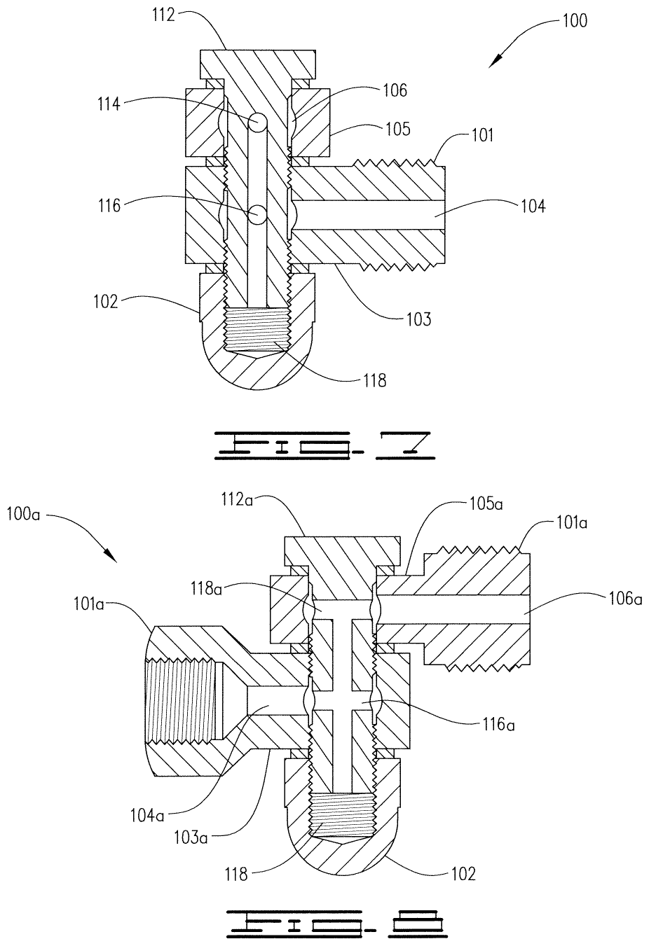

A left swivel elbow 100 is attached to the left side port 50 and a right swivel elbow 100 is attached to the right side port 70. These left and right swivel elbows 100 are independently adjustable. Each swivel elbow 100, FIGS. 5-8, comprises a lower end cap 102, a first washer 90, a lower elbow member 103 with a central channel 104, a second washer 90, an upper elbow member 105 with a central channel 106, a third washer 90 and a threaded bolt 110 defining a head 112 and a lower end 118, and an upper and lower fluid channel 114, 116, adjusted to provide a swivel capacity to each respective swivel elbow 100 with an unrestricted flow pathway to transport liquids, FIGS. 5 and 7.

A left tubing extension 80, having a lower connecting housing 82 and an upper threaded connecting end 84, is further attached to the left lower swivel elbow 100, while a right tubing extension 60, also having a lower connecting housing 62 and an upper threaded connecting end 64, is further attached to the right lower swivel elbow 100 and directed to a location as chosen by the user for the intended project use. Nylon washers 90 are used in the connection of the respective tubing extensions 60, 80 and lower swivel elbows 100.

An upper swivel elbow 101a is attached to each upper threaded connecting end 64, 84, of the left and right tubing extension 60, 80, each upper swivel elbow 100a having a pivot capacity of 0 to 360 degrees with respect to the line of the respective right and left tubing extensions 60, 80. Each upper swivel elbow 101a is further connected to a respective second and third nozzle fitting 65, 85, using a filter boss 66, 86, and a flat tip spray nozzle 68, 88. A respective nozzle body 67, 87 is attached to each first and second nozzle fitting 65, 85, which can also attach a respective plastic safety cap 69, 89. In certain circumstances, special adapters may be used to provide mated threaded connections to allow the first and second nozzle fittings to be adapted to various manufacturers' nozzle bodies, including those employing metric connections and or American standard connections, not shown.

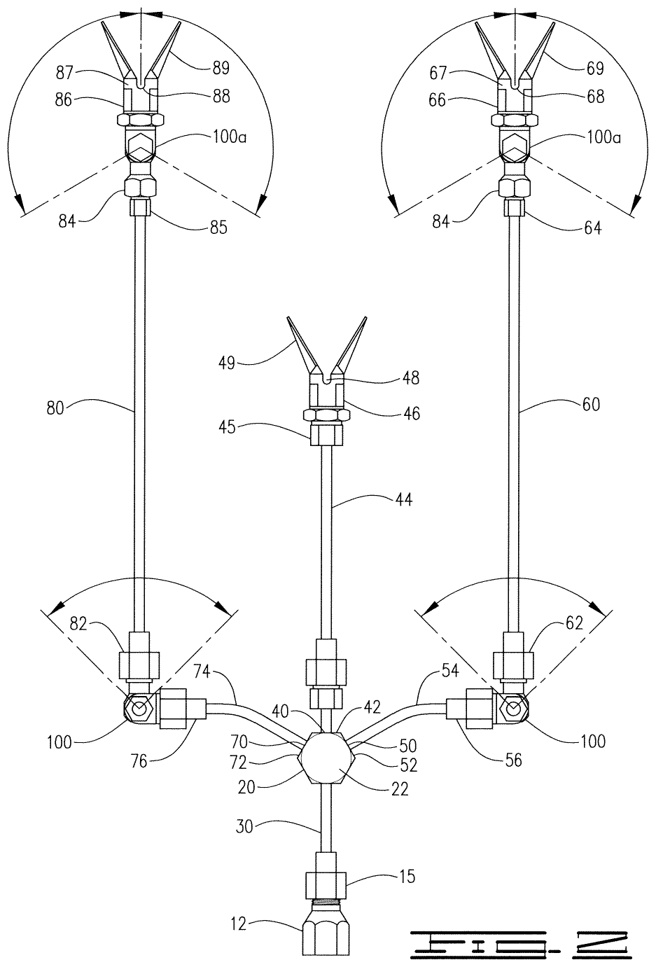

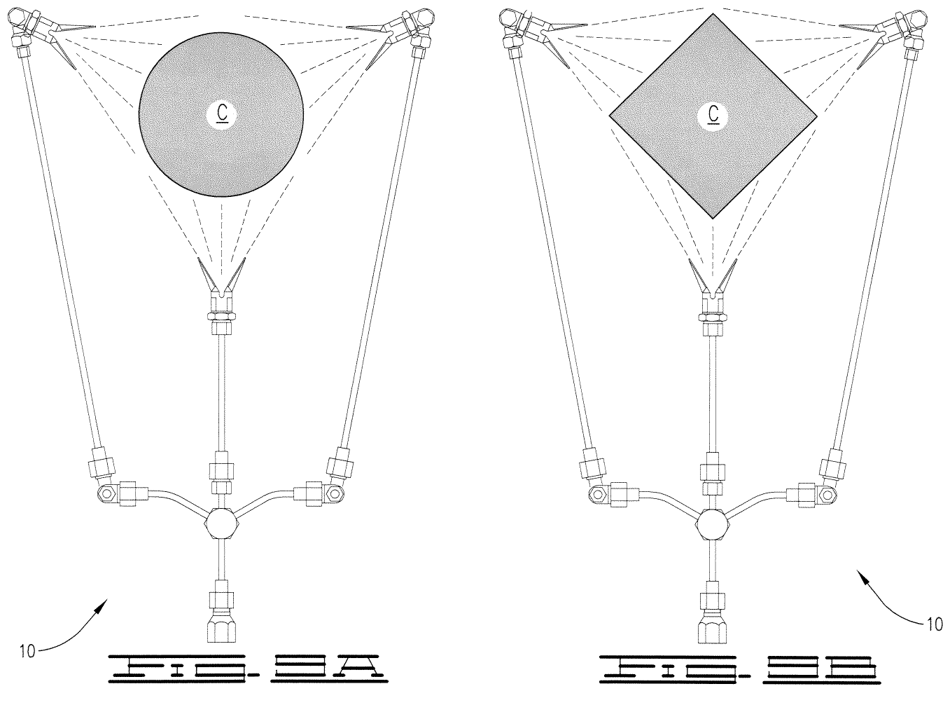

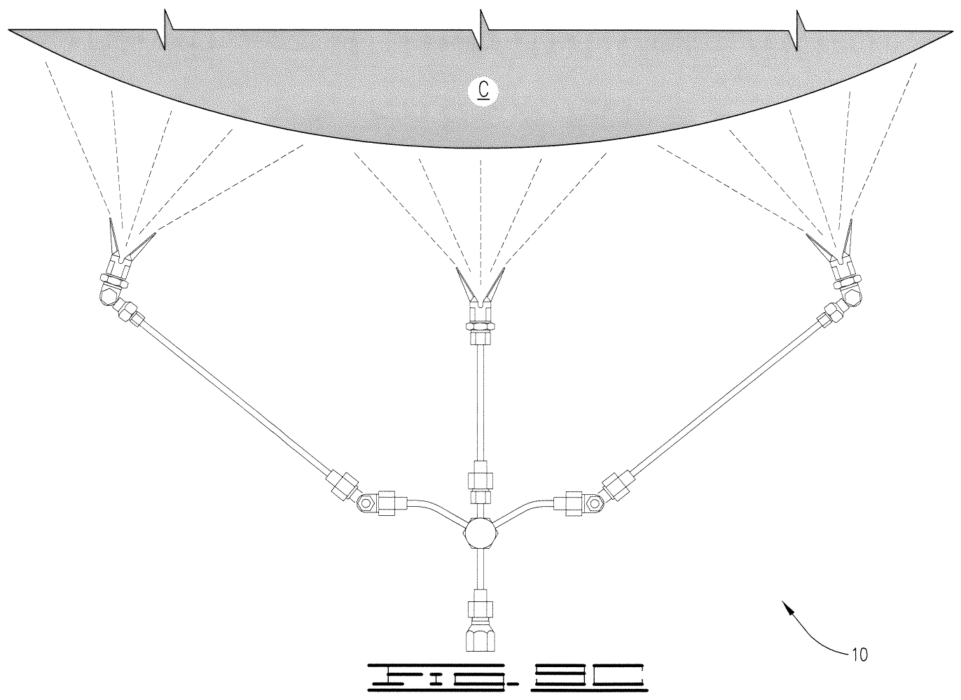

Once the basic assembly is made, the triple shot spray attachment 10 can be adjusted to position each nozzle to a particular angle and direction relative to the spray gun, FIGS. 2 and 9A-9C. Also, each tubing extension 44 and tubing extension 60, 80, can be provided with more than one length. During testing of the product, it was found that each tubular extension 44 could be best suited embodied as a 3″, 6″ and 12″ length, and also for each tubing extension 60, 80. Once assembled, the triple shot spray attachment 10 can be used with a high pressure power washer, an airless paint sprayer, an air compressor, and air pressurized painting device, an epoxy applicator, tar coatings, undercoating applicators, coal tar epoxy application devices, and bed-liner application devices. The triple shot spray attachment 10 may be fully disassembled after use for complete cleaning of the outside and inside surfaces into individual components as shown in the exploded view, FIG. 4. It is common in the industry to simply discard the disposable internal filter 17 and/or each filter boss 46, 66, 86, after each use, since these are generally presented as a cheap and disposable component and troublesome to clean.

The materials used in the triple shot spray attachment 10 are primarily metal, which would include aluminum, stainless steel or other corrosion-resistant metal which can be cleaned with a compatible solvent or water, depending on the product being applied. The washers 90 are already referenced as nylon, but they may be made of any polymeric material which possesses the quality of resilience and resistance to chemical solvents and cleaning products. Materials already on the market which are tested and true are also recommended. If a product is damaged during repeated use, after-market replacement parts are included in this disclosure.

As shown in FIGS. 2-8, the connections between components is generally an outer threaded component with an inner threaded components, or tubing inserted within a port. In the case of the outer threaded and inner threaded components, the drawings are merely to be construed as one embodiment. This in no way dictates that the inner threaded component and outer threaded components are incapable of being presented in reverse. Thus, for example, the swivel elbows 100, 100a may have two elbow members 103, 105, 103a and 105a comprising threaded elbow connections 101, 101a, defining two outer threaded components, one outer and one inner threaded component, or two inner threaded components, with the mating element adapted to connect to the respective presented elbow member connector, 101, 101a. This is true with all the connections within the triple shot spray attachment 10.

While the triple shot spray attachment 10 has been particularly shown and described with reference to a preferred embodiment thereof, it will be understood by those skilled in the art that changes in form and detail may be made therein without departing from the spirit and scope of the invention.

What is claimed is:

1. A triple shot spray attachment, attaching to a spray nozzle of a spray device, comprising:
a filter body containing an internal filter connecting said spray nozzle to said filter body;
tubing attaching said filter body to a separator manifold at a lower end, said separator manifold further defining an upper port, a right side port and a left side port, the separator evenly distributing a liquid from said to each said lower end to each respective; upper port, right side port and said left side port;
a tubular extension directing a flow of liquid from said upper port to a first nozzle fitting to a spray nozzle;
a shaped tubing from said right side port to a lower swivel elbow to a tubing extension connecting an upper swivel elbow, further connecting a second nozzle fitting to a spray nozzle, said upper and lower swivel elbow providing rotation from 0-360 degrees;
a shaped tubing from said left side port to a lower swivel elbow to a tubing extension connecting an upper swivel elbow, further connecting a second nozzle fitting to a spray nozzle, said upper and lower swivel elbow providing rotation from 0-360 degrees, wherein said triple shot spray apparatus has the capacity to apply three equal flow of a liquid contemporaneously to a surface or a shaped target object.

2. The triple shot spray attachment of claim 1, further comprising:
said upper port includes a port fitting from which said tubular extension extends from, with said first nozzle fitting connecting a filter boss attached to said spray nozzle and a safety cap;
said right side port attaching said shaped tubing through a port fitting, said shaped tubing defining a terminal port fitting attaching a lower connecting housing of a tubing extension further defining an upper threaded connecting end, to which said second nozzle fitting attaches a filter boss connecting said nozzle body and said spray nozzle and a safety cap;
said left side port attaching said shaped tubing through a port fitting, said shaped tubing defining a terminal port fitting attaching a lower connecting housing of a tubing extension further defining an upper threaded connecting end, to which said third nozzle fitting attaches a filter boss connecting said nozzle body and said spray nozzle and a safety cap, wherein each said spray nozzle may be independently direct to different locations on a common target contemporaneously.

3. The triple shot spray attachment of claim 1, wherein each connection provides a washer to seal each connection selected from a group of materials including nylon, or any polymeric material which possesses the material quality of resilience and resistance to chemical solvents and cleaning products.

4. The triple shot spray attachment of claim 1, each upper and lower swivel elbow further comprising:
an elbow member connector extending from an upper elbow member defining a central channel and a lower elbow member defining central channel;
a threaded bolt defining a head, a lower end an integrated upper fluid channel and lower fluid channel with a lower end cap securing said lower end of said bolt to pivotally attach said upper elbow member to said lower elbow member providing liquid flow from said lower elbow member to said upper elbow member through the combined and connected central channels view said upper and lower fluid channel, wherein said liquid flow freely and equally from said spray nozzle through all three spray nozzles equally and without restriction to fluid flow.

5. The triple shot spray attachment as disclosed in claim 5, further defining any other element or combination of elements as disclosed in the specification, drawings or claims.
